(19) United States
(12) Patent Application Publication
(10) Pub. No.: US 2024/0204329 A1
(43) Pub. Date: Jun. 20, 2024

(54) Bike Derailleur Battery Case with Bi-directional Charging/Discharging USB C Power Delivery (PD) Converter

(71) Applicant: PHIHONG TECHNOLOGY CO., LTD., Taoyuan City (TW)

(72) Inventor: Ming-Shen Kao, New Taipei City (TW)

(21) Appl. No.: 18/108,661

(22) Filed: Feb. 13, 2023

(30) Foreign Application Priority Data
Dec. 20, 2022 (TW) 111149040

(51) Int. Cl. H01M 50/249; B60R 16/04; H01M 10/46; H01M 50/24

(52) U.S. Cl. CPC H01M 50/249; B60R 16/04; H01M 10/46; H01M 50/24; B60Y 2200/13; H01M 2220/20

(57) ABSTRACT

A bike derailleur battery case with bi-directional charging/discharging USB C PD converter, which includes a charging box body, a waterproof and dustproof cover pivotally connected to the charging box body, a circuit board with bidirectional charging/discharging USB C port been arranged in an accommodating space inside the charging box body, a rechargeable battery pack arranged in the accommodating space inside the charging box and electrically connected to the circuit board, and a one-way charging interface electrically connect to the circuit board.

### CROSS-REFERENCE STATEMENT

All related applications are incorporated by reference. The present application is based on, and claims priority from, Taiwan Patent Application Serial Number 111149040, filed Dec. 20, 2022, the disclosure of which is hereby incorporated by reference herein in its entirety.

### TECHNICAL FIELD

The present invention relates to technology field of battery charging for bike derailleur battery, and more particularly, a bike derailleur battery case with bi-directional charging/discharging USB C power delivery (PD) converter.

### BACKGROUND

In existing bicycles, there are electrical controlled attachments such as electronic shifting devices, suspensions, and display devices. For example, an electronic derailleur for a bicycle requires a battery pack to supply the electric power it needs to operate.

Bicycle that uses such electrical components must have a power source that supplies electric power to display devices, control devices, or shifting devices. Generally, a battery pack is mainly used as such conventional power source for bicycle, and the electric power from the battery pack is used to operate the above-mentioned electrically controlled attachments.

Usually, the afore-mentioned battery pack is a single battery module, which is bulky and needs to be replaced when the power is exhausted. Replacement for the battery module is troublesome and the electrical controlled attachments cannot be operated while performing the replacement of battery module.

For the above reasons, a detachable battery case for charging bike's electronic derailleur battery is proposed, which is independent of the above-mentioned battery module, so that the battery of the electronic transmission can be charged by the battery case when electric power of battery is exhausted. This proposed work can greatly improve the drawbacks of utilizing a single battery pack.

### SUMMARY

Purpose of the present invention is to provide a bike derailleur battery case with bi-directional charging/discharging USB C power delivery (PD) converter, according one aspect of the present invention which includes a charging box body, a waterproof and dustproof cover pivotally connected to the charging box body, a circuit board disposed in an accommodating space inside the charging box body to perform bi-directional charging/discharging through a USB C port, and a rechargeable battery pack arranged inside the charging box body and electrically connected to the circuit board to provide power to a transmission battery through an one-way charging interface electrically connected to the circuit board.

In one preferred embodiment, the bike derailleur battery case further includes a handle clamping ring coupled to the charging box body to fix onto a handle of a bike.

In one preferred embodiment, the one-way charging interface is disposed on bottom of a recessed base formed on upper surface of the charging box body to accommodate the transmission battery.

In one preferred embodiment, the one-way charging interface is a plurality of Pogo pins been placed on the bottom of the recessed base.

In one preferred embodiment, the circuit board is configured to provide an one-way power delivery path between the transmission battery and the rechargeable battery pack by communicating between the transmission battery and a power delivery (PD) controller electrically coupled to the one-way charging interface for offering one-way power delivery functionality from the rechargeable battery pack.

In one preferred embodiment, the circuit board is electrically coupled to an external device via the USB port.

In one preferred embodiment, the circuit board is configured to provide a bi-directional power transmission path between the external device and the rechargeable battery pack by communicating between the external device and a power delivery (PD) controller electrically coupled to the USB C port, when the external device is a power source, power of the external device is controlled by the PD controller to provide the power to charge the rechargeable battery pack through a charging path.

In one preferred embodiment, the charging path includes a plurality of switches controlled by the PD controller and a buck/boost converter to transmit power from the external device to the rechargeable battery pack.

In one preferred embodiment, the circuit board is configured to provide a bi-directional power transmission path between the external device and the rechargeable battery pack by communicating between the external device and a power delivery (PD) controller electrically coupled to the USB C port, when the external device requires power, power of the rechargeable battery pack is controlled by the PD controller to provide the power to the external device through a discharging path.

In one preferred embodiment, the bike derailleur battery case further includes a lighting LED disposed on front end of the charging box body and electrically connected to said circuit board, enabling the rechargeable battery pack to provide power for the lighting LED.

According to another aspect of the present invention, a bike derailleur battery case with bi-directional charging/discharging USB C power delivery (PD) converter is proposed, which includes a charging box body, a waterproof and dustproof cover pivotally connected to the charging box body, a circuit board disposed in an accommodating space inside the charging box body to perform bi-directional charging/discharging through a USB C port, a rechargeable battery pack arranged inside the charging box body and electrically connected to the circuit board to provide power to a transmission battery through an one-way charging interface electrically connected to the circuit board, and a handle clamping ring coupled to the charging box body to fix onto a handle of a bike, wherein the handle clamping ring and the charging box body is relatively rotated.

In one preferred embodiment, the one-way charging interface is disposed on bottom of a recessed base formed on upper surface of the charging box body to accommodate the transmission battery.

In one preferred embodiment, the one-way charging interface is a plurality of Pogo pins been placed on the bottom of the recessed base.

In one preferred embodiment, the circuit board is configured to provide an one-way power delivery path between the transmission battery and the rechargeable battery pack by communicating between the transmission battery and a power delivery (PD) controller electrically coupled to the one-way charging interface for offering one-way power delivery functionality from the rechargeable battery pack.

In one preferred embodiment, the circuit board is electrically coupled to an external device via the USB port.

In one preferred embodiment, the circuit board is configured to provide a bi-directional power transmission path between the external device and the rechargeable battery pack by communicating between the external device and a power delivery (PD) controller electrically coupled to the USB C port, (i) when the external device is a power source, power of the external device is controlled by the PD controller to provide the power to charge the rechargeable battery pack through a charging path; (ii) when the external device requires power, power of the rechargeable battery pack is controlled by the PD controller to provide the power to the external device through a discharging path.

In one preferred embodiment, the charging path includes a plurality of switches controlled by the PD controller and a buck/boost converter to transmit power from the external device to the rechargeable battery pack.

In one preferred embodiment, the bike derailleur battery case further includes a lighting LED disposed on front end of the charging box body and electrically connected to the circuit board, enabling the rechargeable battery pack to provide power for the lighting LED.

### BRIEF DESCRIPTION OF THE DRAWINGS

The components, characteristics and advantages of the present invention may be understood by the detailed descriptions of the preferred embodiments outlined in the specification and the drawings attached:

FIG. 1A shows front sectional view of the structure of the bike derailleur battery case proposed by the present invention.

FIG. 1B shows side sectional view of the structure of the bike derailleur battery case proposed by the present invention.

FIG. 1C shows rear view of the structure of the bike derailleur battery case proposed by the present invention.

FIG. 2A shows 3D structure of the bike derailleur battery case including the charging box body with the waterproof and dustproof cover been opened, proposed by the present invention.

FIG. 2B shows 3D structure of the bike derailleur battery case including the charging box body with the waterproof and dustproof cover been closed, proposed by the present invention.

FIG. 3 illustrates an internal circuit block diagram of a bike derailleur battery case with bi-directional charging/discharging USB C PD converter.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The purpose of the present invention is to provide a bike derailleur battery case with bi-directional charging/discharging USB C power delivery (PD) converter. The bike derailleur battery case has a built-in battery pack and a bi-directional charging/discharging USB C power delivery (PD) converter, which can be used to transfer electric power from an external coupled AC adapter to the battery pack or to provide electric power from the battery pack to the external connected electronic equipment. Generally, the bike derailleur battery case is portable and convenient for charging a bike derailleur battery.

The converter built-in in the bike derailleur battery case can be a tool or a charger that is utilized new USB 3.0 power delivery (PD) regulations, which includes bi-directional power delivery up to 60 W. The built-in PD converter having bi-directional PD functionality; therefore, it can be used as a charger. For example, as a charging converter, which can allow an electronic device/equipment to receive up to 60 W of electric power through its USB C port. For example, as a portable converter, which can perform charging or discharging to the chargeable battery pack and also can provide electric power to various connected electronic devices through its USB C port with maximum power 60 W. The amount of electric power that can be provided to the connected electronic devices depends on the power capacity (unit: Whr) of the built-in battery pack.

Built-in converter of the bike derailleur battery case utilizes the power delivery or USB C PD standard, which allows an electronic device/equipment to transmit or receive up to 60 W of electric power with various voltage and current distributions through its USB C port (supporting bi-directional power flow). These electronic products allow discrete voltages of 5, 9, 12, 15 and 20 V and currents up to 3 A. The PD standard uses a PD contract to establish a relationship between a PD device (in this case a USB C converter) and an attached device. This contract is an agreement between two PD devices connected via a Type C cable. There are many subtle distinctions in the agreement, but the basic limitations of individual device are: (1) the source must establish and maintain an agreed-upon voltage within +/−4% while delivering up to the agreed-upon maximum current; (2) the sink can source any amount of current from 0 A all the way up to the agreed-upon maximum current. The current cannot exceed the maximum value for more than a few milliseconds.

A PD charger/provider/power supply is a device in a PD contract that agrees to supply power to its partner device. A PD consumer/load/receiver is a device in the PD contract that agrees to accept power from its partner device. A PD dual role port (DRP) device is a device that can act as a source or sink, depending on what is connected and its internal state. The USB C converter is a DRP device.

The bike derailleur battery case with bi-directional charging/discharging USB C PD converter can provide USB C source streaming limited only by the available battery pack, with a choice of longer-run or shorter-run battery packs to customize the user experience, and the battery pack size, larger or smaller as needed, is ergonomically preferred.

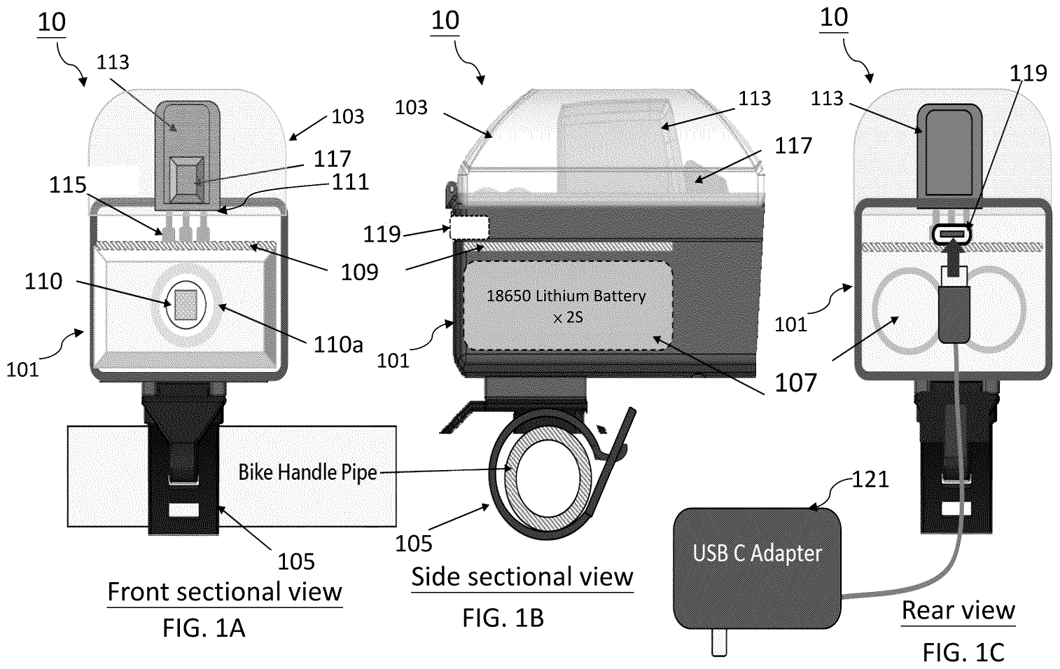

FIGS. 1A-1C depict structure of the bike derailleur battery case 10 proposed by the present invention, which includes a charging box body 101, a waterproof and dustproof cover 103 pivotally connected to the charging box body 101, and a handle clamping ring 105 used to fix the charging body 101 onto bike's handle. Interior of the charging box body 101 has an accommodating space to dispose a Lithium battery pack 107 and a printed circuit board 109 with USB C bi-directional charging/discharging converter circuit, where the Lithium battery pack 107 is electrically connected to the printed circuit board 109. Front side of charging box body 101 is disposed with a lighting LED 110 and a LED lens 110a, where the lighting LED 110 is electrically connected to both the printed circuit board 109 and the Lithium battery pack 107, and the LED lens 110a is configured to focus light beam emitting from the lighting LED 110. Upper surface of the charging box body 101 has a recessed base 111 formed to accommodate a transmission battery 113, where the bottom of the recessed base 111 is disposed with a plurality of Pogo pins 115 to be a charging interface for the transmission battery 113. Front end of the recessed base 111 is disposed with a buckle 117 to lock the transmission battery 113. One end of individual Pogo pin 115 is electrically connected to the printed circuit board 109 while the other end of the Pogo pin 115 is passed through the recessed base 111 to electrically connect to the transmission battery 113. Rear side of the charging box body 101 has a USB C port 119 disposed and configured to electrically connected to the printed circuit board 109, the USB C port 119 can be utilized to charge the Lithium battery pack 107 via an external coupled AC adapter 121 with USB C interface or to deliver power from the Lithium battery pack 107 to an external coupled electronic device.

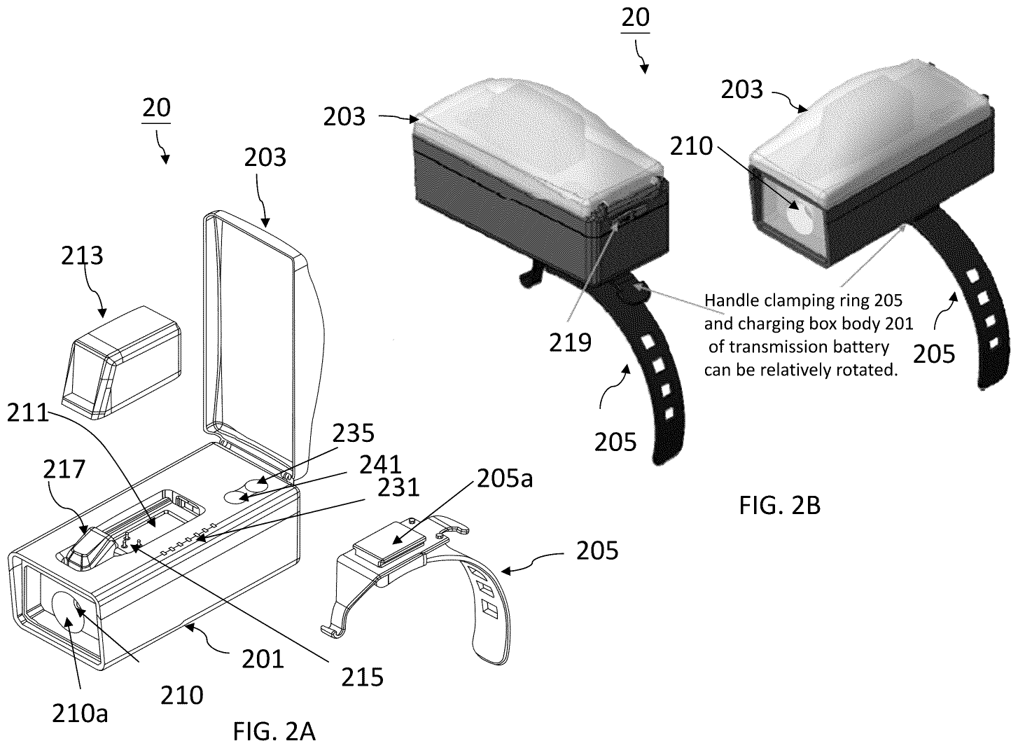

FIGS. 2A-2B show 3D diagram of the proposed bike derailleur battery case 20. FIG. 2A depicts 3D structure of the bike derailleur battery case 20 including the charging box body 201 with the waterproof and dustproof cover 203 opened, the transmission battery 213 and the handle clamping ring 205. In FIG. 2A, detailed structure of the charging box body 201 is shown, which illustrates a lighting LED 110 and a LED lens disposed on its front end of the charging box 201, a recessed base 211 formed on its upper surface with plurality of Pogo pins 215 been placed to accommodate the transmission battery 213, a set of battery charging indicator 231 placed on the edge of its upper surface for indicating charging status of transmission battery 213, a lighting mode switch 241 and a power spark switch 235 been disposed on its upper surface near the waterproof and dustproof cover 203, and a handle clamping ring 205 having a lug platform 205a with slots and belt tie been mortise jointed its bottom portion. FIG. 2B shows 3D diagram of the proposed bike derailleur battery case 20 with its waterproof and dustproof cover 203 closed, diagram on the left demonstrates that the charging box 201 has been placed with its long axis parallel to bike's handle showing that USB C port 219 is disposed on the rear side; diagram on the right demonstrate that the charging box 201 has been placed with its long axis perpendicular to bike's handle showing that lighting LED 210 is disposed on front side. FIG. 2B also shows that the handle clamping ring 205 and charging box body 201 can be relatively rotated.

In one embodiment of the present invention, an external coupled charger, such as an AC adapter, used to charge the battery pack installed in the bike derailleur battery case or the battery to deliver electric power to the connected external electronic device can utilize bi-directional converter circuit with PD specification of USB C PD3.0&QC4.0 to transfer electric power. Detailed circuit design of the bike derailleur battery case with bi-directional charging/discharging USB C PD converter will be described in the following paragraphs.

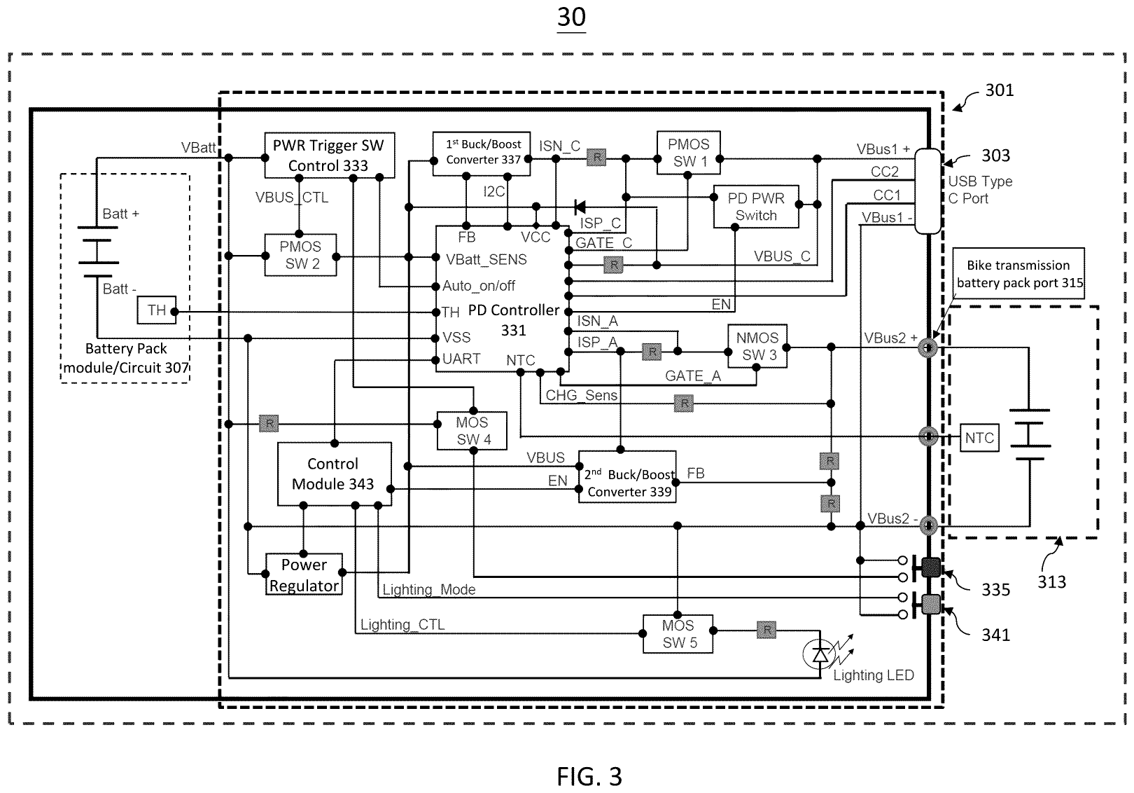

FIG. 3 illustrates an internal circuit block diagram 30 of a bike derailleur battery case with bi-directional charging/discharging USB C PD converter, which incorporates bi-directional charging/discharging USB C converter 301 of the bike derailleur battery case and the built-in rechargeable battery pack 307 to store electric power and to provide electric power to external connected electronic device. The bike derailleur battery case itself has the functionality of a power bank, which is connected to transmission battery 313 of the bike's electronic transmission and can charge the transmission battery 313 of the bike at the same time.

USB C port 303 of the bike derailleur battery case is a bi-directional charging/discharging port, which enables that external power source can provide electric power up to 60 W to the battery pack of the bike derailleur battery case and can also deliver electric power up to 60 W to external coupled electronic device. Transmission battery charging terminal (or called bike transmission battery pack port) 315 of the bike derailleur battery case can be used as charging interface for the transmission battery 313, where the bike derailleur battery case can provide electric power about 2 W to the transmission battery 313 through the transmission battery charging terminal 315.

Please refer to FIG. 3, the following section explains the working principles between the bi-directional charging/discharging USB C converter 301 of the bike derailleur battery case and an external coupled AC adapter with USB C charging interface (not shown). In the cases that CC1/CC2 pins of the USB C port 303 haven't detected any connection signal of external electronic device for a predetermined period of time or for avoiding static damage of the connected transmission battery 313, the power delivery (PD) controller 331 will be set into sleep mode, the PD controller 313 will notify the power trigger control unit (PWR Trigger SW control) 333 by sending a triggering signal through its Auto_on/off pin and enable the power trigger control unit (PWR Trigger SW control) 333 sending out VBUS_CTL control signal to control PMOS SW2 switch being opened, forcing all power supply paths being off Even if the IC of PD controller 331 enters the sleep mode, there will still be tens of mA consumption, and this current will damage the lifetime of the rechargeable battery pack, such as transmission battery 307. To avoid this drawback, the circuitry design of the bi-directional charging/discharging USB C converter 301 should include automatically power off functionality. As long as the bi-directional charging/discharging USB C converter 301 (i.e. power circuitry) is not used for a period of time, it will automatically cut off the PMOS SW2, so that all power supply paths are disconnected and the current drops below 1 pA. Power supply circuitry can be restarted by pressing the power trigger switch (PWR Spark Switch) 335 once, the power trigger control unit (PWR Trigger SW control) 333 will control PMOS SW2 switch into a closed circuit, enabling that the current of the rechargeable battery pack 307 flows through VCC pin of the PD controller 331 to resume normal operation.

Continued with reference to the circuit block diagram in FIG. 3, the USB C Port 303 of the bike derailleur battery case is a bi-directional port for charging/discharging. When an external coupled device, such as USB C type AC adapter, is inserted into the USB C port 303, the PD controller 331 communicates with the external coupled device via the CC1/CC2 pins. As the communication protocol announces that external coupled device become source terminal, electric power from the USB C type adapter enters the PMOS SW1 switch through VBus 1 terminal of the USB C port 303. At this moment, the PMOS SW1 switch is set to be in a closed state, and the PD PWR switch is set to be in a opened state, and the power enters the ISP_C and ISN_C current detection nodes from PMOS SW1, and is detected by the PD controller 331 then enters the first buck/boost converter 337. At the same time, the PD controller 331 controls PMOS SW2 to be in closed state via its Auto_on/off pin, monitors the voltage of Vbatt provided by its Vbatt SNS pin, and utilizes its I2C pin to control the first buck/boost converter 337 for determining the rechargeable battery pack 307 should be charged in trickle or constant current (CC) or constant voltage (CV) charging mode. Electric power is then converted by the first buck/boost converter 337 to charge the rechargeable battery pack 307, the charging power depends on the capacity of the rechargeable battery pack 307, and the maximum charging power can be up to 60 W. At the same time, the bike derailleur battery case can simultaneously provide the transmission battery 313 with about 2 W of electric power from the rechargeable battery pack 307 via the transmission battery charging terminal 315, and the wattage of the charging power depends on the capacity and demand of the transmission battery.

Continued with reference to the circuit block diagram in FIG. 3, the USB C Port 303 of the bike derailleur battery case is a bi-directional port for charging/discharging. When an external coupled (electronic) device is inserted into the USB C port 303 and requires to provide electric power into it, the USB C port 303 becomes a sink port, the PD controller 331 communicates with the coupled external powered device through the CC1 and CC2 pins and utilizes the I2C pin to control the first buck/boost converter 337 for determining the external coupled device should be charged in trickle or constant current (CC) or constant voltage (CV) charging mode. Electric power from the rechargeable battery pack 307 sinks into the ISN_C and ISP_C current detection nodes, and is monitored by the PD controller 331, and then the current flows into the node between PMOS SW1 switch and the PD PWR switch. At this moment, the PD controller 331 determines that connected device (through USB C port 303) is a sink and controls the PMOS SW1 to be opened and the PD PWR switch to be closed, and the electric power can flow to VBus1+ terminal of the USB C Port 303 through the PD PWR switch to provide power to the connected device. How much current/voltage needs to be transmitted to the external device is determined by the confirmed communication protocol between the PD controller 331 and the external device. The charging power depends on the capacity of the rechargeable battery pack 307 and the external device, and the maximum charging power can be up to 60 W. At the same time, the bike derailleur battery case can simultaneously provide the transmission battery 313 with about 2 W of electric power from the rechargeable battery pack 307 via the transmission battery charging terminal 315, and the wattage of the charging power depends on the capacity and demand of the transmission battery.

Continued with reference to the circuit block diagram in FIG. 3, the transmission battery charging terminal (or called bike transmission battery pack port) 315 only offers unidirectional charging function for the transmission battery 313. When the transmission battery is inserted into the transmission battery charging terminal 315, the PD controller 331 detects voltage of the transmission battery through its CHG_SNS pin, electric power of the chargeable battery pack 307 passes through the second buck/boost converter 339 via the PMOS SW2 then enters into the ISP_A and ISN_A current detection nodes, electric current converted from the second buck/boost converter 339 (acted as charging current) is monitored by the PD controller 313. At the same time, control module 343 monitors the Vbatt voltage sensed by VBatt_SENS pin of the PD controller through its UART pin and enables the second buck/boost converter 339 to start charging via the EN pin, and the charging current flows into the closed NMOS SW3 switch then flows into the VBus2+ pin to charge the transmission battery 313.

Continued with reference to the circuit block diagram in FIG. 3, if the USB C Port 303 is plugged with a device that requires charging, it does not supply power. When the PD controller 331 has entered into sleep mode, normal power supply state of the PD controller 331 can be restored by pressing the power trigger switch 335 to activate the power trigger control unit (PWR Trigger SW Control) 333 enabling the PMOS SW2 switch into a closed circuit. Similar action can be performed, if the bike derailleur battery case is to be used alone for charging.

Continued with reference to the circuit block diagram in FIG. 3, the bike derailleur battery case is not only a charger, but also a power bank, which can also provide electricity for lighting LED at night. LED lighting is activated by pressing the lighting mode switch 341 to make the control module 343 controlling the MOS SW 5 switch into working state through the Lighting_CTL pin, enabling that the LED driving current flows through the lighting LED to make it showing high/low brightness lighting or flashing lighting, which is depended on the actual design. The lighting LED can be turned off by pressing and holding the lighting mode switch 341 for about 2-3 seconds.

While various embodiments of the present invention have been described above, it should be understood that they have been presented by a way of example and not limitation. Numerous modifications and variations within the scope of the invention are possible. The present invention should only be defined in accordance with the following claims and their equivalents.

What is claimed is:

1. A bike derailleur battery case with bi-directional charging/discharging USB C power delivery (PD) converter comprising:
a charging box body;
a waterproof and dustproof cover pivotally connected to said charging box body;
a circuit board disposed in an accommodating space inside said charging box body to perform bi-directional charging/discharging through a USB C port; and
a rechargeable battery pack arranged inside said charging box body and electrically connected to said circuit board to provide power to a transmission battery through an one-way charging interface electrically connected to said circuit board.

2. The bike derailleur battery case with bi-directional charging/discharging USB C PD converter of claim 1, further including a handle clamping ring coupled to said charging box body to fix onto a handle of a bike.

3. The bike derailleur battery case with bi-directional charging/discharging USB C PD converter of claim 1, wherein said one-way charging interface is disposed on bottom of a recessed base formed on upper surface of said charging box body to accommodate said transmission battery.

4. The bike derailleur battery case with bi-directional charging/discharging USB C PD converter of claim 3, wherein said one-way charging interface is a plurality of Pogo pins been placed on said bottom of said recessed base.

5. The bike derailleur battery case with bi-directional charging/discharging USB C PD converter of claim 4, wherein said circuit board is configured to provide an one-way power delivery path between said transmission battery and said rechargeable battery pack by communicating between said transmission battery and a power delivery (PD) controller electrically coupled to said one-way charging interface for offering one-way power delivery functionality from said rechargeable battery pack.

6. The bike derailleur battery case with bi-directional charging/discharging USB C PD converter of claim 1, wherein said circuit board is electrically coupled to an external device via said USB port.

7. The bike derailleur battery case with bi-directional charging/discharging USB C PD converter of claim 6, wherein said circuit board is configured to provide a bi-directional power transmission path between said external device and said rechargeable battery pack by communicating between said external device and a power delivery (PD) controller electrically coupled to said USB C port, when said external device is a power source, power of said external device is controlled by said PD controller to provide said power to charge said rechargeable battery pack through a charging path.

8. The bike derailleur battery case with bi-directional charging/discharging USB C PD converter of claim 7, wherein said charging path includes a plurality of switches controlled by said PD controller and a buck/boost converter to transmit power from said external device to said rechargeable battery pack.

9. The bike derailleur battery case with bi-directional charging/discharging USB C PD converter of claim 6, wherein said wherein said circuit board is configured to provide a bi-directional power transmission path between said external device and said rechargeable battery pack by communicating between said external device and a power delivery (PD) controller electrically coupled to said USB C port, when said external device requires power, power of said rechargeable battery pack is controlled by said PD controller to provide said power to said external device through a discharging path.

10. The bike derailleur battery case with bi-directional charging/discharging USB C PD converter of claim 1, further including a lighting LED disposed on front end of said charging box body and electrically connected to said circuit board, enabling said rechargeable battery pack to provide power for said lighting LED.

11. A bike derailleur battery case with bi-directional charging/discharging USB C power delivery (PD) converter comprising:
a charging box body;
a waterproof and dustproof cover pivotally connected to said charging box body;
a circuit board disposed in an accommodating space inside said charging box body to perform bi-directional charging/discharging through a USB C port;
a rechargeable battery pack arranged inside said charging box body and electrically connected to said circuit board to provide power to a transmission battery through an one-way charging interface electrically connected to said circuit board; and
a handle clamping ring coupled to said charging box body to fix onto a handle of a bike, wherein said handle clamping ring and said charging box body is relatively rotated.

12. The bike derailleur battery case with bi-directional charging/discharging USB C PD converter of claim 11, wherein said one-way charging interface is disposed on bottom of a recessed base formed on upper surface of said charging box body to accommodate said transmission battery.

13. The bike derailleur battery case with bi-directional charging/discharging USB C PD converter of claim 12, wherein said one-way charging interface is a plurality of Pogo pins been placed on said bottom of said recessed base.

14. The bike derailleur battery case with bi-directional charging/discharging USB C PD converter of claim 13, wherein said circuit board is configured to provide an one-way power delivery path between said transmission battery and said rechargeable battery pack by communicating between said transmission battery and a power delivery (PD) controller electrically coupled to said one-way charging interface for offering one-way power delivery functionality from said rechargeable battery pack.

15. The bike derailleur battery case with bi-directional charging/discharging USB C PD converter of claim 11, wherein said circuit board is electrically coupled to an external device via said USB port.

16. The bike derailleur battery case with bi-directional charging/discharging USB C PD converter of claim 15, wherein said circuit board is configured to provide a bi-directional power transmission path between said external device and said rechargeable battery pack by communicating between said external device and a power delivery (PD) controller electrically coupled to said USB C port, (i) when said external device is a power source, power of said external device is controlled by said PD controller to provide said power to charge said rechargeable battery pack through a charging path; (ii) when said external device requires power, power of said rechargeable battery pack is controlled by said PD controller to provide said power to said external device through a discharging path.

17. The bike derailleur battery case with bi-directional charging/discharging USB C PD converter of claim 16, wherein said charging path includes a plurality of switches controlled by said PD controller and a buck/boost converter to transmit power from said external device to said rechargeable battery pack.

18. The bike derailleur battery case with bi-directional charging/discharging USB C PD converter of claim 11, further including a lighting LED disposed on front end of said charging box body and electrically connected to said circuit board, enabling said rechargeable battery pack to provide power for said lighting LED.
